(19) United States
(12) Patent Application Publication
(10) Pub. No.: US 2021/0382867 A1
(43) Pub. Date: Dec. 9, 2021

(54) NON-TRANSITORY COMPUTER-READABLE STORAGE MEDIUM FOR STORING INFORMATION PROCESSING PROGRAM, INFORMATION PROCESSING DEVICE, AND INFORMATION PROCESSING METHOD

(71) Applicant: FUJITSU LIMITED, Kawasaki-shi (JP)

(72) Inventors: Yuho Shiinoki, Akashi (JP); Naoki Umeda, Akashi (JP); Hisashi Sugawara, Yokohama (JP); Yoshitaka Suehiro, Kobe (JP); Chikara Saito, Chigasaki (JP); Shigeo Yoshikawa, Himeji (JP)

(73) Assignee: FUJITSU LIMITED, Kawasaki-shi (JP)

(21) Appl. No.: 17/317,327

(22) Filed: May 11, 2021

(30) Foreign Application Priority Data
Jun. 8, 2020 (JP) 2020-099180

(51) Int. Cl. G06F 16/22; G06F 16/23; G06F 16/26; G06F 16/2458

(52) U.S. Cl. CPC G06F 16/2272; G06F 16/2458; G06F 16/26; G06F 16/2365

(57) ABSTRACT

An information processing method includes: specifying a number of data of data respectively falling within one or a plurality of ranges respectively corresponding to a plurality of granularities stored in a memory in association with a specific identifier among a plurality of data; and determining a granularity of data of when outputting information regarding the specific identifier according to whether the number of data respectively falling within all the ranges corresponding to a same granularity in the plurality of granularities is equal to or larger than a predetermined threshold.

### CROSS-REFERENCE TO RELATED APPLICATION

This application is based upon and claims the benefit of priority of the prior Japanese Patent Application No. 2020-99180, filed on Jun. 8, 2020, the entire contents of which are incorporated herein by reference.

### FIELD

The embodiment discussed herein is related to a non-transitory computer-readable storage medium storing an information processing program, an information processing device, and an information processing method.

### BACKGROUND

In recent years, expectations have been rising for digital transformation, which creates new services and businesses by distributing and utilizing various digitized data.

Specifically, in recent years, for example, implementation of digital transformation by using Internet of Things (IoT), AI, or the like based on digital technologies such as cloud, mobility, big data and social technologies has been progressing.

Here, in a case where technologies such as IoT and AI as above are used, for example, a large amount of diverse data including personal information, confidential information, and the like (for example, data transmitted from a personal terminal such as a smartphone) is collected. Therefore, a business operator that engages in the digital transformation (hereinafter also simply referred to as a business operator) needs to use the collected data after performing anonymization processing needed for the collected data, for example (see, for example, Patent Documents 1 and 2).

Examples of the related art include Japanese Laid-open Patent Publication No. 2016-031567 and International Publication Pamphlet No. WO 2011/145401.

### SUMMARY

According to an aspect of the embodiments, an information processing method includes: specifying a number of data of data respectively falling within one or a plurality of ranges respectively corresponding to a plurality of granularities stored in a memory in association with a specific identifier among a plurality of data; and determining a granularity of data of when outputting information regarding the specific identifier according to whether the number of data respectively falling within all the ranges corresponding to a same granularity in the plurality of granularities is equal to or larger than a predetermined threshold.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for describing a configuration of an information processing system;

FIG. 2 is a diagram for describing a specific example of anonymization processing;

FIG. 3 is a diagram for describing a specific example of the anonymization processing;

FIG. 4 is a diagram for describing a specific example of the anonymization processing;

FIG. 5 is a diagram for describing a specific example of the anonymization processing in a case where a missing value occurs;

FIG. 6 is a diagram for describing a specific example of the anonymization processing in the case where a missing value occurs;

FIG. 7 is a diagram for describing a specific example of the anonymization processing in the case where a missing value occurs;

FIG. 8 is a diagram for describing a hardware configuration of an information processing device;

FIG. 9 is a block diagram of functions of the information processing device;

FIG. 10 is a flowchart for describing an outline of anonymization processing according to a first embodiment;

FIG. 11 is a flowchart for describing details of the anonymization processing according to the first embodiment;

FIG. 12 is a flowchart for describing details of the anonymization processing according to the first embodiment;

FIG. 13 is a flowchart for describing details of the anonymization processing according to the first embodiment;

FIG. 14 is a flowchart for describing details of the anonymization processing according to the first embodiment;

FIG. 15 is a flowchart for describing details of the anonymization processing according to the first embodiment;

FIG. 16 is a diagram for describing a specific example of correspondence information;

FIG. 17 is a diagram for describing a specific example of target data;

FIG. 18 is a diagram for describing a specific example of the target data;

FIG. 19 is a diagram for describing a specific example of statistical information;

FIG. 20 is a diagram for describing a specific example of the statistical information;

FIG. 21 is a diagram for describing a specific example of output data;

FIG. 22 is a diagram for describing a specific example of the statistical information;

FIG. 23 is a diagram for describing a specific example of the output data;

FIG. 24 is a diagram for describing a specific example of the statistical information;

FIG. 25 is a diagram for describing a specific example of the output data;

FIG. 26 is a diagram for describing another specific example of the anonymization processing according to the first embodiment;

FIG. 27 is a diagram for describing another specific example of the anonymization processing according to the first embodiment; and

FIG. 28 is a diagram for describing another specific example of the anonymization processing according to the first embodiment.

### DESCRIPTION OF EMBODIMENTS

Here, in the above-described anonymization processing, for example, the personal information and the like are anonymized by collecting data having overlapping combinations of quasi-identifiers. Therefore, when an information processing device that performs the anonymization processing (hereinafter also simply referred to as an information processing device) performs the anonymization processing for data, the information processing device refers to an appearance state of combinations of quasi-identifiers in generated data (received data), for example.

However, in this case, the information processing device is not able to start the anonymization processing until a large amount of data including combinations of quasi-identifiers is accumulated. Therefore, the Information processing device may not be able to efficiently perform the anonymization processing for data.

Therefore, in one aspect, an object of the present embodiments is to provide an information processing program, an information processing device, and an information processing method for enabling anonymization according to an appearance state of combinations of quasi-identifiers.

[Configuration of Information Processing System]

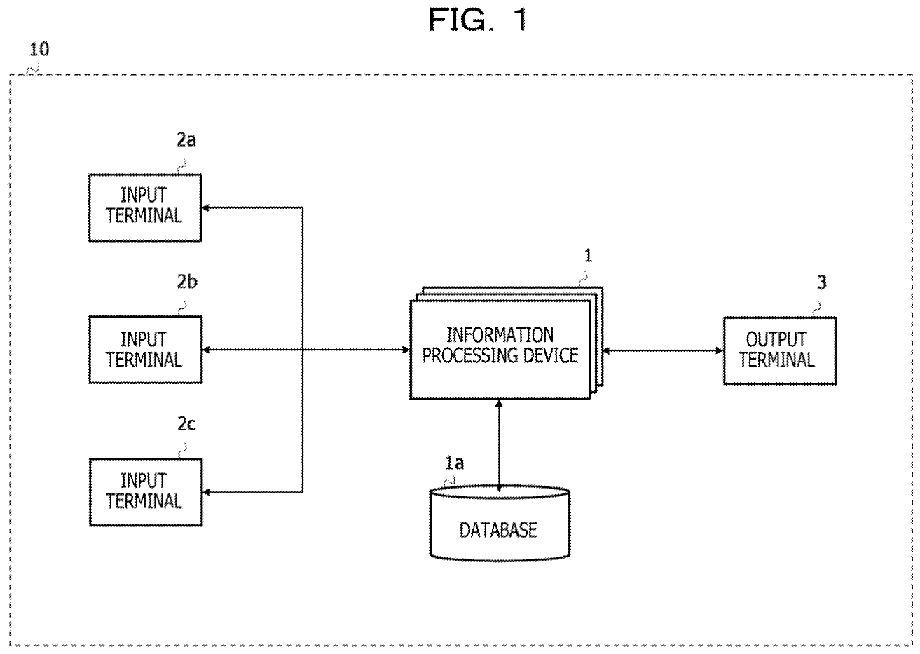

First, a configuration of an information processing system 10 will be described. FIG. 1 is a diagram for describing a configuration of the information processing system 10.

The Information processing system 10 includes an information processing device 1 as a physical machine or a virtual machine including a database 1a, and input terminals 2a, 2b, and 2c (hereinafter these are also collectively referred to as input terminal(s) 2) used by an operator who generates data to be stored in the database 1a and the like (hereinafter also simply referred to as an operator). The input terminal 2 is, for example, a personal computer (PC), a smartphone, or the like. Furthermore, the information processing system 10 includes an output terminal 3 used by a user who, for example, browses data stored in the database 1a (hereinafter also simply referred to as a user). The output terminal 3 is, for example, a PC, a smartphone, or the like, similarly to the input terminal 2. Hereinafter, description will be given assuming that the database 1a is provided inside the information processing device 1, but the database 1a may be provided outside the information processing device 1.

Specifically, in a case of receiving data (streaming data) transmitted from each of the input terminals 2, the information processing device 1 stores the received data in the database 1a, for example. Then, in a case of receiving a browsing request for data transmitted from the output terminal 3, for example, the information processing device 1 extracts the data corresponding to the received browsing request from the database 1a and transmits the extracted data to the output terminal 3.

Here, each data stored in the database 1a may include personal information, confidential information, and the like. Therefore, in the case of transmitting the data corresponding to the browsing request to the output terminal 3, for example, the information processing device 1 needs to perform anonymization processing for the data.

Specifically, the information processing device 1 performs the anonymization processing for the data by collecting data having overlapping combinations of quasi-identifiers, for example. More specifically, the information processing device 1 performs the anonymization processing for data by referring to statistical information indicating the appearance state of combinations of quasi-identifiers in the received data from the input terminal 2, for example, (hereinafter also simply referred to as statistical information). Hereinafter, a specific example of the anonymization processing will be described.

[Specific Example of Anonymization Processing (1)]

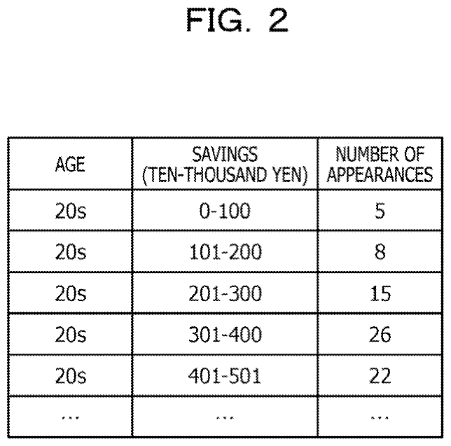

FIGS. 2 to 4 are diagrams for describing specific examples of the anonymization processing.

[Specific Example (1) of Statistical Information]

First, a specific example of the statistical information will be described. FIG. 2 is a diagram for describing a specific example of the statistical information.

The statistical information illustrated in FIG. 2 includes “age” and “savings” in which information corresponding to the age and savings of each target person included in the data input from the input terminal 2 is set, as items. Furthermore, the statistical information illustrated in FIG. 2 includes the “number of appearances” in which the number of appearances of data including both of the Information set in “age” and the information set in “savings” is set, as an item.

Specifically, in the statistical information illustrated in FIG. 2, “20s” is set as the “age”, “0-100 (ten-thousand yen)” is set as the “savings”, and “5 (times)” is set as the “number of appearances” in the first-row information.

Furthermore, in the statistical information illustrated in FIG. 2, “20s” is set as the “age”, “101-200 (ten-thousand yen)” is set as the “savings”, and “8 (times)” is set as the “number of appearances” in the second-row information. Description of other information included in FIG. 2 is omitted.

[Specific Example of Extracted Data (1)]

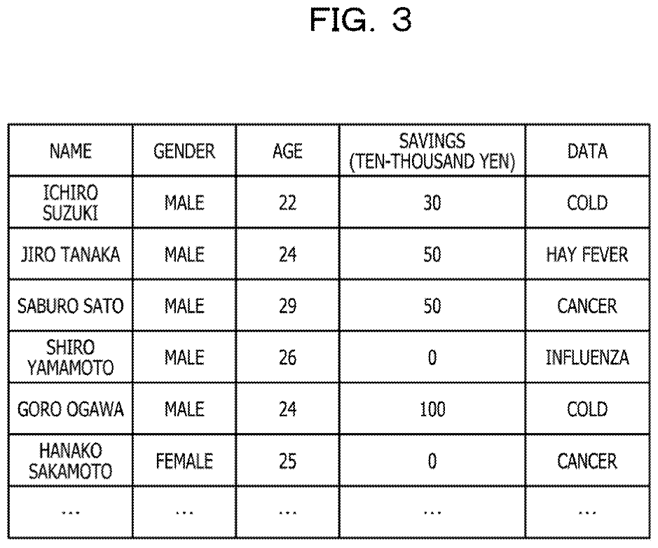

Next, a specific example of data extracted from the database 1a (hereinafter, the data is also referred to as extracted data) in response to a browsing request transmitted from the output terminal 3 will be described. FIG. 3 is a specific example of the extracted data.

The extracted information illustrated in FIG. 3 includes “name”, “gender”, “age”, and “savings” In which information corresponding to the name, gender, age, and savings of each target person included in the data input from the input terminal 2 is set, as items. Furthermore, the extracted data illustrated in FIG. 3 includes “data” in which information other than the name, gender, age, and savings included in the data input from the input terminal 2 is set, as an item. Hereinafter, the “data” will be described assuming that a disease name of each target person is set. Furthermore, description will be given assuming that the combination of “age” and “savings” is a combination of quasi-identifiers in the data.

Specifically, in the extracted data illustrated in FIG. 3, “Ichiro Suzuki” is set as the “name”, “male” is set as the “gender”, and “22 (years old)” is set as the “age”, “30 (ten-thousand yen)” is set as the “savings”, and “cold” is set as the “data” in the first-row information.

Furthermore, in the extracted data illustrated in FIG. 3, “Jiro Tanaka” is set as the “name”, “male” is set as the “gender”, and “24 (years old)” is set as the “age”, “50 (ten-thousand yen)” is set as the “savings”, and “hay fever” is set as the “data” in the second-row information. Description of other information included in FIG. 3 is omitted.

[Specific Example of Output Data (1)]

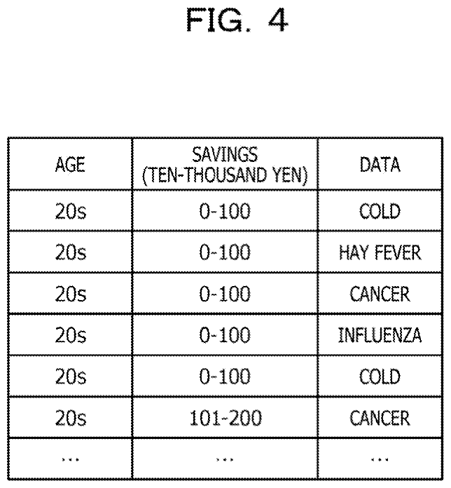

Next, a specific example of data obtained by anonymizing the extracted data illustrated in FIG. 3 (hereinafter, the data is also referred to as output data) will be described. FIG. 4 is a specific example of the output data.

The output data illustrated in FIG. 4 includes “age”, “savings”, and “data” among the items included in the extracted data described in FIG. 3.

Specifically, in the output data illustrated in FIG. 4, “20s” is set as the “age” and “0-100 (ten-thousand yen)” is set as the “savings”, and “cold” is set as “data” in the first-row information.

Furthermore, in the output data illustrated in FIG. 4, “20s” is set as the “age” and “0-100 (ten-thousand yen)” is set as the “savings”, and “hay fever” is set as “data” in the second-row information.

That is, for example, in a case of performing k-anonymization with k of 3, the information processing device 1 performs, as illustrated in FIG. 4, the anonymization processing for data in which a value of 3 or larger is set to the “number of appearances” in the statistical information described in FIG. 2, in the extracted data described in FIG. 3.

[Specific Example of Anonymization Processing (2)]

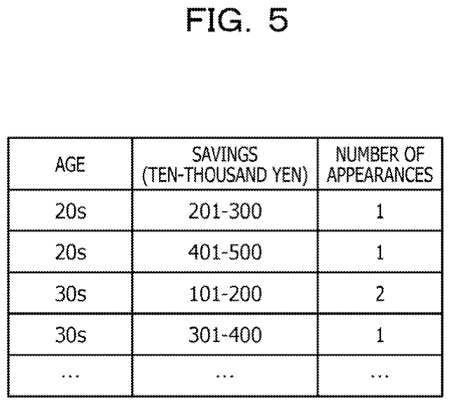

Next, a specific example of the anonymization processing in a case where a missing value occurs in the output data because the number of data received from the input terminal 2 is not sufficient will be described. FIGS. 5 to 7 are diagrams for describing specific examples of the anonymization processing in a case where a missing value occurs.

[Specific Example (2) of Statistical Information]

First, a specific example of the statistical information will be described. FIG. 5 is a diagram for describing a specific example of the statistical information. The statistical information illustrated in FIG. 5 has the same items as the statistical information described in FIG. 2.

Specifically, in the statistical information illustrated in FIG. 5, “20s” is set as the “age”, “201-300 (ten-thousand yen)” is set as the “savings”, and “1 (time)” is set as the “number of appearances” in the first-row information.

Furthermore, in the statistical information illustrated in FIG. 5, “20s” is set as the “age”, “401-500 (ten-thousand yen)” is set as the “savings”, and “1 (time)” is set as the “number of appearances” in the second-row information. Description of other information included in FIG. 5 is omitted.

[Specific Example of Extracted Data (2)]

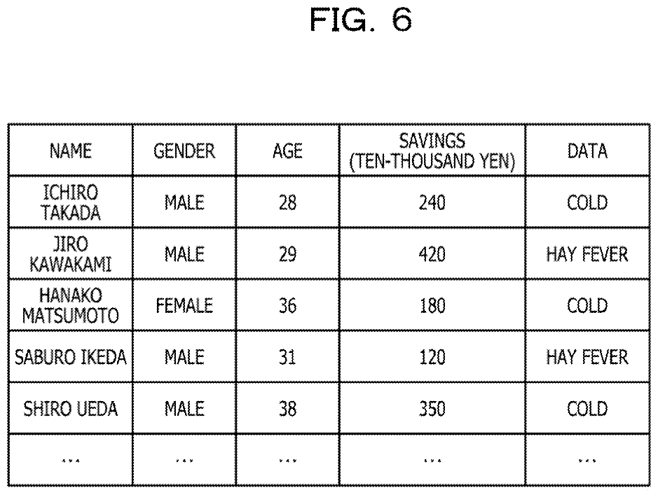

Next, a specific example of the extracted data will be described. FIG. 6 is a specific example of the extracted data. The extracted data illustrated in FIG. 6 has the same items as the extracted data described in FIG. 3.

Specifically, in the extracted data illustrated in FIG. 6, “Ichiro Takada” is set as the “name”, “male” is set as the “gender”, and “28 (years old)” is set as the “age”, “240 (ten-thousand yen)” is set as the “savings”, and “cold” is set as the “data” in the first-row information.

Furthermore, in the extracted data illustrated in FIG. 6, “Jiro Kawakami” is set as the “name”, “male” is set as the “gender”, and “29 (years old)” is set as the “age”, “420 (ten-thousand yen)” is set as the “savings”, and “hay fever” is set as the “data” in the second-row information. Description of other information included in FIG. 6 is omitted.

[Specific Example of Output Data (2)]

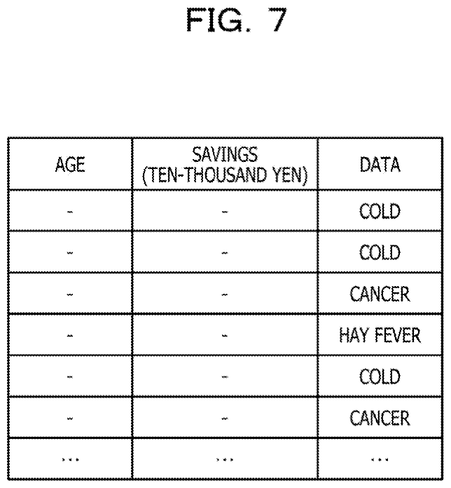

Next, a specific example of the output data will be described. FIG. 7 is a specific example of the output data. The output data illustrated in FIG. 7 has the same items as the output data described in FIG. 4.

Specifically, in the output data illustrated in FIG. 7, “-” indicating a missing value is set as each of the “age” and the “savings”, and “cold” is set as the “data” in the first-row information.

Furthermore, in the output data illustrated in FIG. 7, “-” is set as each of the “age” and the “savings”, and “hay fever” is set as the “data” in the second-row information. Description of other information included in FIG. 7 is omitted.

That is, in the case of using the statistical information Including a large number of data in which a value of “3” or larger is not set to the “number of appearances”, the information processing device 1 generates output data including many missing values, as illustrated in FIG. 7. Therefore, in this case, the information processing device 1 is not able to output data useful to the user to the output terminal 3.

Furthermore, for example, in a case of creating a model by machine learning, the operator needs to perform preprocessing of complementing the missing values.

However, the work associated with such preprocessing usually imposes an enormous burden on the operator and may not be efficient.

Therefore, in the case of performing the anonymization processing, the information processing device 1 in the present embodiment specifies the number of data of data respectively falling within one or a plurality of ranges respectively corresponding to a plurality of granularities stored in association with a quasi-identifier (hereinafter also referred to as a specific identifier) among a plurality of data transmitted from the input terminal 2.

Then, the information processing device 1 determines the granularity of data of when outputting information regarding the quasi-identifier according to whether the number of data respectively falling within all the ranges corresponding to the same granularity is equal to or larger than a predetermined threshold.

That is, the information processing device 1 according to the present embodiment dynamically changes the granularity of data to be anonymized according to an accumulation status of data transmitted from the input terminal 2 (an appearance state of data having overlapping combinations of quasi-identifiers). Then, the Information processing device 1 generates output data not including missing values and transmits the output data to the output terminal 3.

As a result, the information processing device 1 can output useful data to the output terminal 3 while anonymizing the personal information, confidential information, and the like.

[Hardware Configuration of Information Processing System]

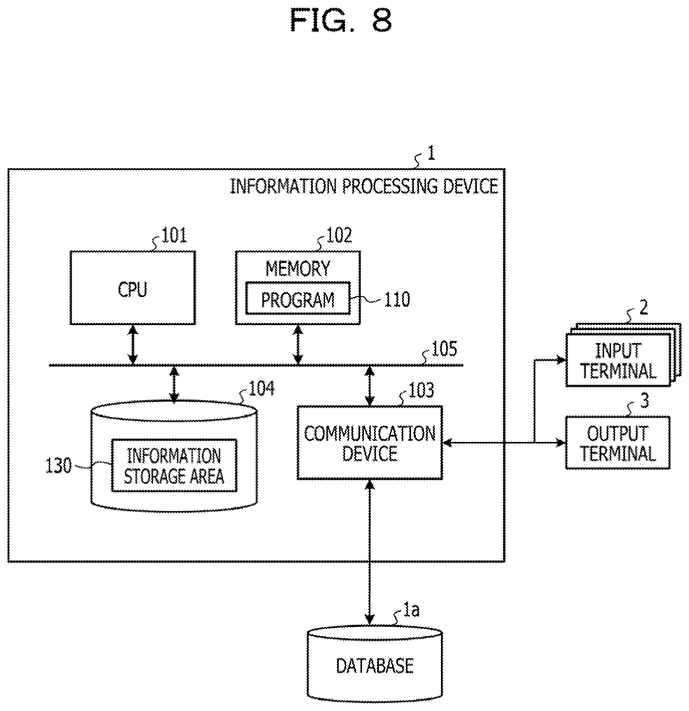

Next, a hardware configuration of the information processing system 10 will be described. FIG. 8 is a diagram for describing a hardware configuration of the information processing device 1.

As illustrated in FIG. 8, the information processing device 1 includes a CPU 101 as a processor, a memory 102, a communication device 103, and a storage medium 104. Each of the units is interconnected via a bus 105.

The storage medium 104 has, for example, a program storage area (not illustrated) for storing a program 110 for performing the anonymization processing for data transmitted from the input terminal 2. Furthermore, the storage medium 104 includes, for example, a storage unit 130 (hereinafter, also referred to as an information storage area 130) for storing information to be used when performing the anonymization processing. Note that the storage medium 104 can be, for example, a hard disk drive (HDD) or a solid state drive (SSD).

The CPU 101 executes the program 110 loaded from the storage medium 104 into the memory 102 to perform the anonymization processing.

Furthermore, the communication device 103 communicates with the input terminal 2, the output terminal 3, and the database 1a via a network (not illustrated), for example.

[Functions of Information Processing System]

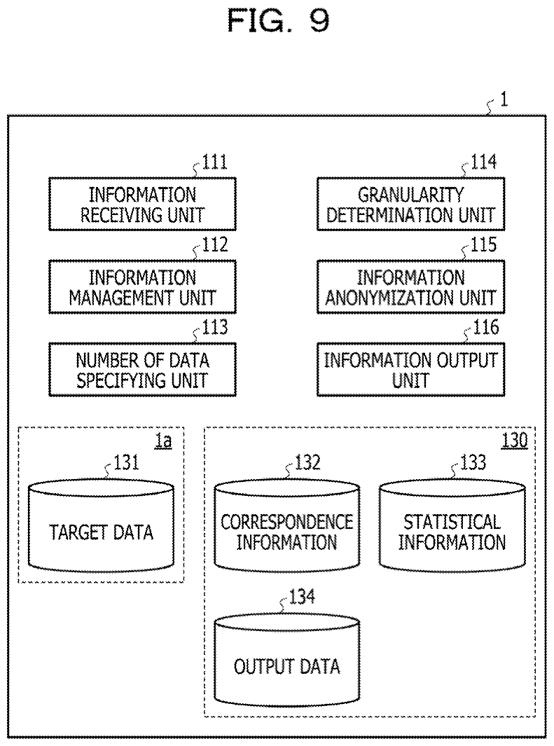

Next, the functions of the information processing system 10 will be described. FIG. 9 is a block diagram of functions of the information processing device 1.

As illustrated in FIG. 9, the information processing device 1 implements various functions including an information receiving unit 111, an information management unit 112, and a number of data specifying unit 113, a granularity determination unit 114, an information anonymization unit 115, and an information output unit 116 as hardware such as the CPU 101 and the memory 102 organically cooperate with the program 110, for example.

Furthermore, the information processing device 1 stores data 131 (hereinafter also referred to as target data 131) in the database 1a, as illustrated in FIG. 9, for example. Moreover, the information processing device 1 stores, for example, correspondence information 132, statistical information 133, and output data 134 in the information storage area 130, as illustrated in FIG. 9.

The information receiving unit 111 receives the target data 131 transmitted from the input terminal 2, for example.

Furthermore, the information receiving unit 111 receives the correspondence information 132 transmitted from the input terminal 2, for example. Correspondence information 132 is information indicating the granularity associated with each of the quasi-identifiers included in the target data 131.

Moreover, the information receiving unit 111 receives the browsing request for the target data 131 transmitted from the output terminal 3, for example.

The information management unit 112 stores the target data 131 received by the information receiving unit 111 in the database 1a, for example.

Furthermore, the information management unit 112 stores the correspondence information 132 received by the information receiving unit 111 in the information storage area 130, for example.

Moreover, in the case where the information receiving unit 111 receives the browsing request for the target data 131, the information management unit 112 extracts the target data 131 corresponding to the browsing request from the database 1a.

The number of data specifying unit 113 refers to the correspondence information 132 stored in the information storage area 130, and specifies the number of data of the target data 131 respectively corresponding to one or a plurality of ranges respectively corresponding to a plurality of granularities corresponding to the quasi-identifiers included in each target data 131 among a plurality of target data 131 stored in the information storage area 130.

The granularity determination unit 114 determines the granularity of data of when outputting information regarding the quasi-identifier included in each target data 131 according to whether the number of data (the number of data specified by the number of data specifying unit 113) respectively falling within all the ranges corresponding to the same granularity is equal to or larger than a predetermined threshold.

The information anonymization unit 115 anonymizes the target data 131 stored in the information storage area 130 according to the granularity determined by the granularity determination unit 114. Specifically, the information anonymization unit 115 anonymizes the target data 131 (the target data 131 corresponding to the browsing request) extracted by the information management unit 112, for example.

For example, the information output unit 116 outputs the output data 134 that is the target data 131 anonymized by the information anonymization unit 115 to the output terminal 3. The statistical information 133 will be described below.

[Outline of First Embodiment]

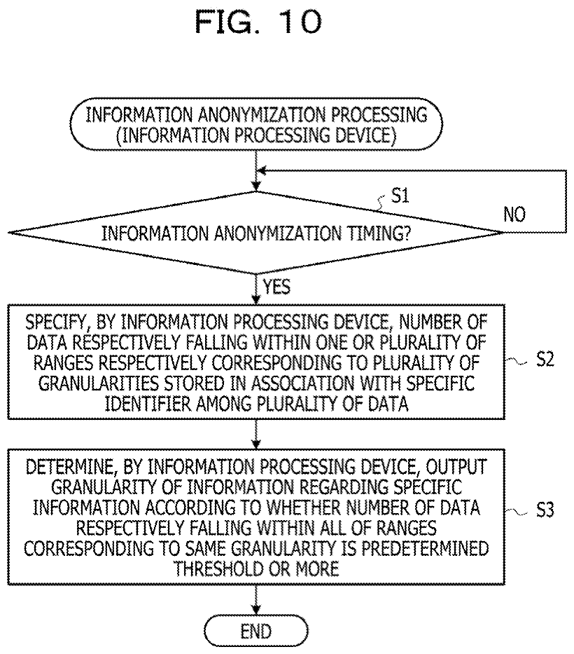

Next, an outline of a first embodiment will be described. FIG. 10 is a flowchart for describing an outline of the anonymization processing according to the first embodiment.

As illustrated in FIG. 10, the information processing device 1 waits until information anonymization timing comes (NO in S1). The information anonymization timing may be, for example, timing at which the target data 131 is extracted in response to reception of the browsing request from the output terminal 3.

Then, in the case where the information anonymization timing has come (YES in S1), the information processing device 1 specifies the number of data of data respectively falling within one or a plurality of ranges respectively corresponding to a plurality of granularities stored in association with the quasi-identifiers among the plurality of target data 131 (S2).

Then, the information processing device 1 determines an output granularity regarding the quasi-identifier according to whether the number of data respectively falling within all the ranges corresponding to the same granularity is equal to or larger than the predetermined threshold (S4).

That is, the information processing device 1 according to the present embodiment dynamically changes the granularity of data to be anonymized according to an accumulation status of data transmitted from the input terminal 2 (an appearance state of data having overlapping combinations of quasi-identifiers). Then, the information processing device 1 generates output data not including missing values and transmits the output data to the output terminal 3.

As a result, the information processing device 1 can output useful data to the output terminal 3 while anonymizing the personal information, confidential information, and the like.

[Details of First Embodiment]

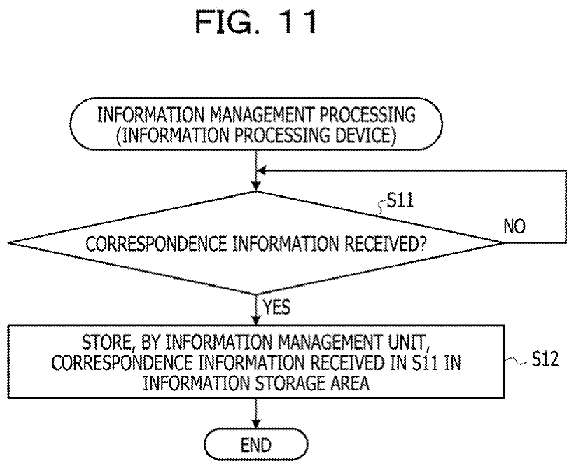

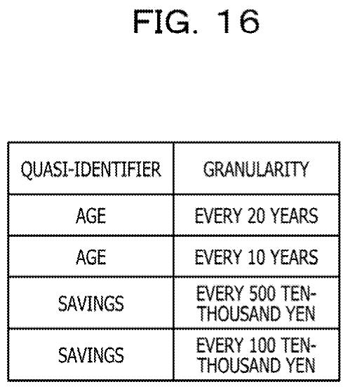

Next, the details of the first embodiment will be described. FIGS. 11 to 15 are flowcharts for describing details of the anonymization processing according to the first embodiment. Furthermore, FIGS. 16 to 28 are diagrams for describing details of the anonymization processing according to the first embodiment.

[Information Management Processing]

First, processing of managing the correspondence information 132 (hereinafter also referred to as information management processing) in the anonymization processing will be described. FIG. 11 is a flowchart for describing the information management processing.

As illustrated in FIG. 11, the information receiving unit 111 of the information processing device 1 waits until receiving the correspondence information 132 transmitted from the input terminal 2, for example (NO in S11).

Then, in the case of receiving the correspondence information 132 (YES in S11), the information management unit 112 of the information processing device 1 stores the correspondence information 132 received in the processing in S11 in the information storage area 130 (S12). Hereinafter, a specific example of the correspondence information 132 will be described.

[Specific Example of Correspondence Information]

FIG. 16 is a diagram for describing a specific example of correspondence information 132.

The correspondence information 132 illustrated in FIG. 16 includes “quasi-identifier” in which identification Information of the each quasi-identifier is set and “granularity” in which the granularity corresponding to the each quasi-identifier is set, as items.

Specifically, in the correspondence information 132 illustrated in FIG. 16, “age” is set as the “quasi-identifier” and “every 20 years” is set as the “granularity” in the first-row information.

Furthermore, in the correspondence information 132 illustrated in FIG. 16, “age” is set as the “quasi-Identifier” and “every 10 years” is set as the “granularity” in the second-row information.

Furthermore, in the correspondence information 132 illustrated in FIG. 16, “savings” is set as the “quasi-identifier” and “every 500 ten-thousand yen” is set as the “granularity” in the third-row information.

Moreover, in the correspondence information 132 illustrated in FIG. 16, “savings” is set as the “quasi-identifier” and “every 100 ten-thousand yen” is set as the “granularity” in the fourth-row information.

That is, the correspondence information 132 illustrated in FIG. 16 indicates that the quasi-identifiers included in the target data 131 are“age” and “savings”. Furthermore, the correspondence information 132 illustrated in FIG. 16 indicates that, in the case where the anonymization processing for the target data 131 is performed, “every 20 years” or “every 10 years” is used as the granularity corresponding to the “age”, and “500 ten-thousand yen” or “100 ten-thousand yen” is used as the granularity corresponding to the “savings”.

[Data Storage Processing]

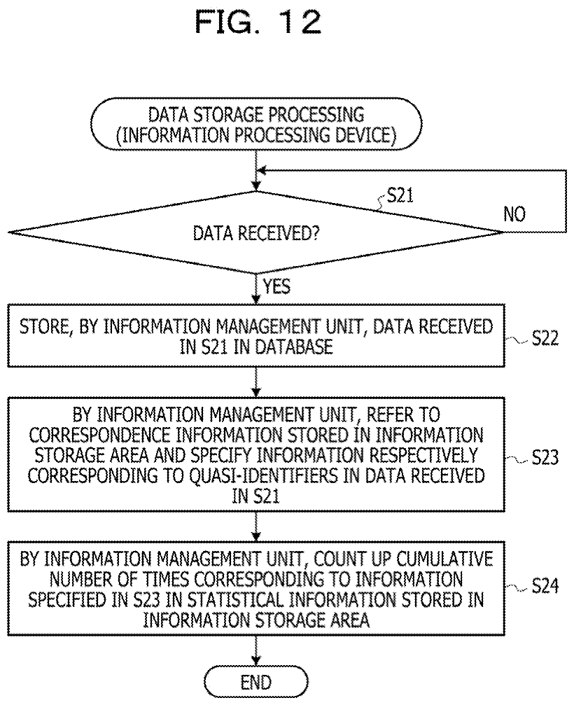

Next, processing of storing the target data 131 transmitted from the input terminal 2 in the database 1a (hereinafter also referred to as data storage processing) in the anonymization processing will be described. FIG. 12 is a flowchart for describing the data storage processing.

As illustrated in FIG. 12, the information receiving unit 111 waits until receiving the target data 131 transmitted from the input terminal 2, for example (NO in S21).

Then, in the case of receiving the target data 131 transmitted from the input terminal 2 (YES in S21), the information management unit 112 stores the target data 131 received in the processing in S21 in the database 1a (S22). Hereinafter, a specific example of the target data 131 will be described.

[Specific Example of Target Data]

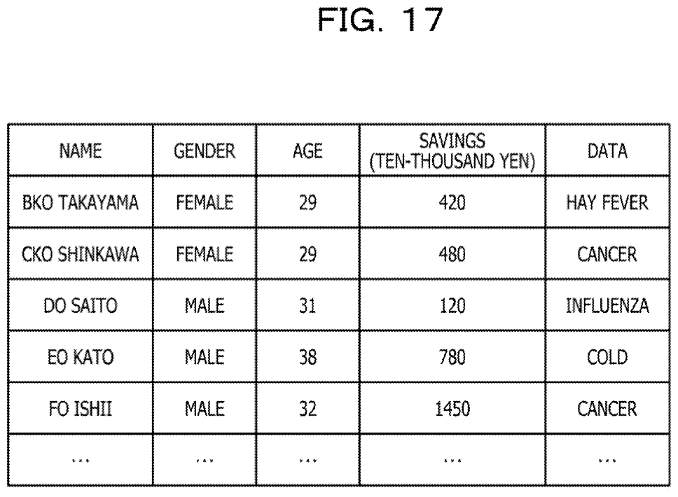

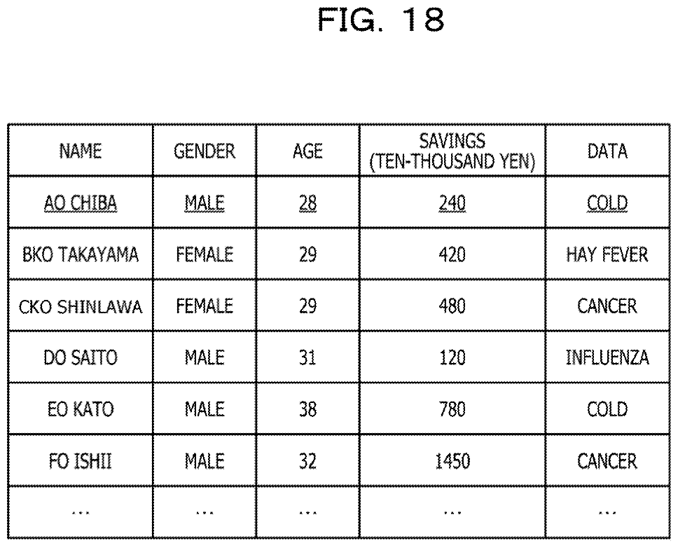

FIGS. 17 and 18 are diagrams for describing specific examples of the target data 131. Specifically, FIG. 17 is a diagram for describing a specific example of a state of the database 1a before the target data 131 received in the processing in S21 is stored, and FIG. 18 is a diagram for describing a state of the database 1a after the target data 131 received in the processing in S21 is stored.

The target data 131 illustrated in FIGS. 17 and 18 has the same items as the extracted data described in FIG. 3 and the like.

Specifically, in the target data 131 illustrated in FIG. 17, “Bko Takayama” is set as the “name”, “female” is set as the “gender”, and “29 (years old)” is set as the “age”, “420 (ten-thousand yen)” is set as the “savings”, and “hay fever” is set as the “data” in the first-row information.

Furthermore, in the target data 131 illustrated in FIG. 17, “Cko Shinkawa” is set as the “name”, “female” is set as the “gender”, and “29 (years old)” is set as the “age”, “480 (ten-thousand yen)” is set as the “savings”, and “cancer” is set as the “data” in the second-row information. Description of other information included in FIG. 17 is omitted.

Then, for example, in the case of receiving new target data 131 in the processing in S21, the information management unit 112 further stores the new target data 131 in the database 1a, as illustrated in the underlined part in FIG. 18. Hereinafter, description will be given assuming that the target data 131 illustrated in the first row in FIG. 18 is the target data 131 received in the processing in S21.

Returning to FIG. 12, the information management unit 112 refers to the correspondence Information 132 stored in the information storage area 130, and specifies information corresponding to each of the quasi-identifiers in the target data 131 received in the processing in S21 (S23).

Specifically, “28 (years old)” is stored as the “age” and “240 (ten-thousand yen)” is stored as the “savings” in the first row of the target data 131 illustrated in FIG. 18. Therefore, the information management unit 112 specifies “28 (years old)” and “240 (ten-thousand yen)” in the processing in S23.

Then, the information management unit 112 counts up the cumulative number of times corresponding to the information specified in the processing in S23 in the statistical information 133 stored in the information storage area 130 (S24). Hereinafter, a specific example of the statistical information 133 will be described.

[Specific Example of Statistical Information]

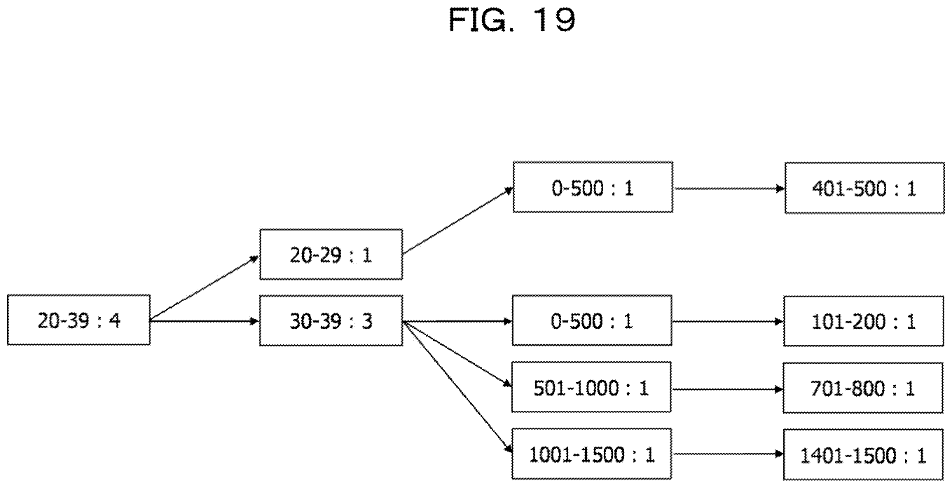

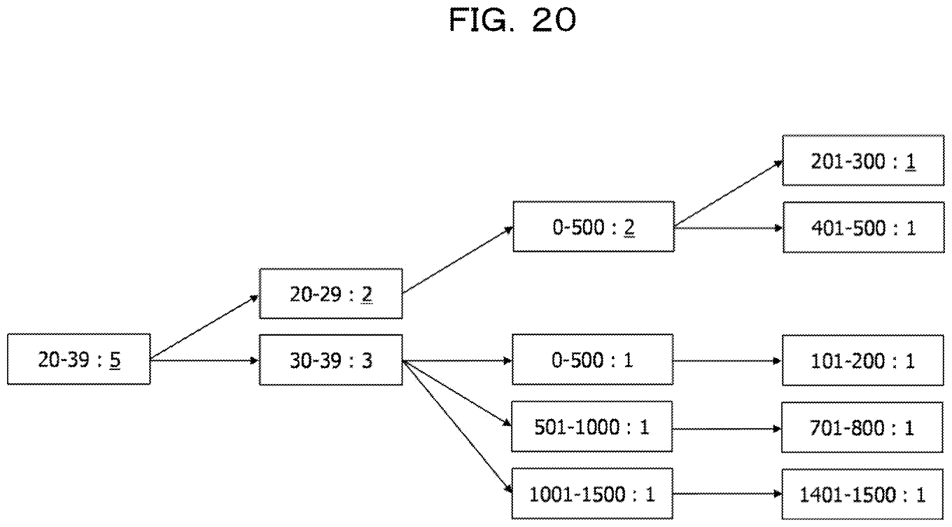

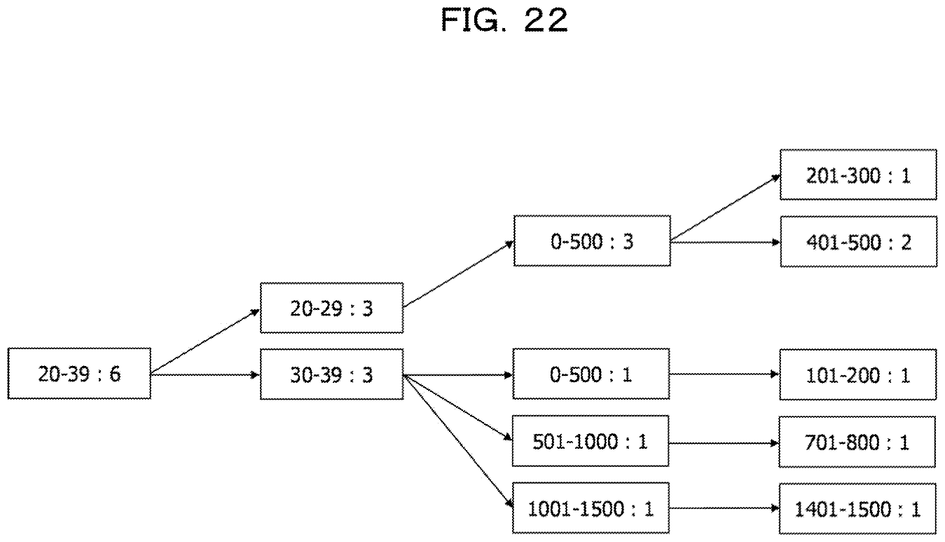

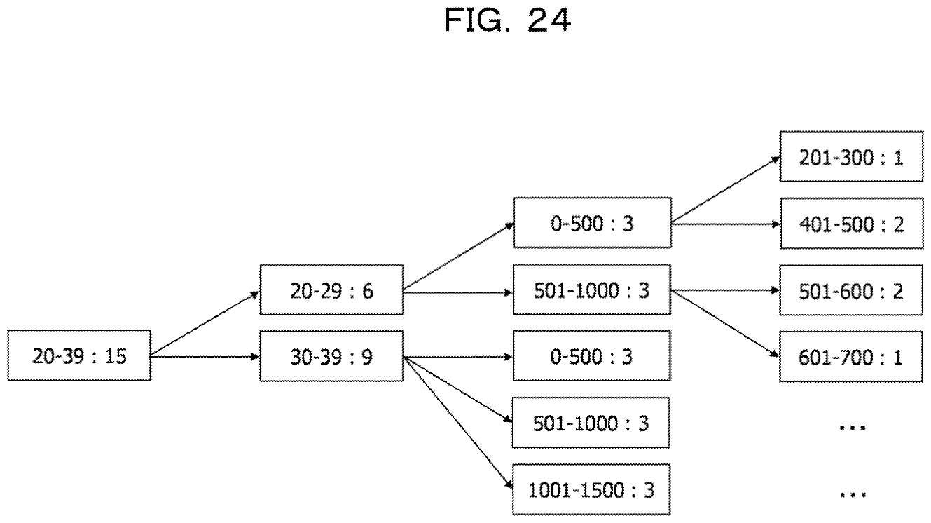

FIGS. 19, 20, 22, and 24 are diagrams for describing specific examples of the statistical information 133. Specifically, FIG. 19 illustrates a specific example of the statistical information 133 before the cumulative number of times is counted up in the processing in S24, and FIG. 20 illustrates a specific example of the statistical information 133 after the cumulative number of times is counted up in the processing in S24. Note that description of FIGS. 22 and 24 will be described below.

In the statistical information 133 illustrated in FIG. 19, “20-39:4” indicates that the cumulative number of times (the number of receptions from the input terminal 2) of the target data 131 to which the age from “20 (years old)” to “39 (years old)” is set in the “age” is “4”.

Furthermore, in the statistical information 133 illustrated in FIG. 19, “20-29:1” indicates that the cumulative number of times of the target data 131 to which the age from “20 (years old)” to “29 (years old)” is set in the “age” is “1” in the target data 131 to which the age from “20 (years old)” to “39 (years old)” is set in the “age”. Furthermore, “30-39:3” indicates that the cumulative number of times of the target data 131 to which the age from “30 (years old)” to “39 (years old)” is set in the “age” is “3” In the target data 131 to which the age from “20 (years old)” to “39 (years old)” is set in the “age”.

Furthermore, in the statistical information 133 illustrated in FIG. 19, “0-500:1” connected to “20-29:1” indicates that the number of cases of the target data 131 in which the amount from “0 (ten-thousand yen)” to “500 (ten-thousand yen)” is set as the “savings” is “1” in the target data 131 to which the age from “20 (years old)” to “29 (years old)” is set as the “age”.

Furthermore, in the statistical information 133 illustrated in FIG. 19, “0-500:1” connected to “30-39:3” indicates that the number of cases of the target data 131 in which the amount from “0 (ten-thousand yen)” to “500 (ten-thousand yen)” is set as the “savings” is “1” in the target data 131 to which the age from “30 (years old)” to “39 (years old)” is set as the “age”. Furthermore, “501-1000:1” Indicates that the number of cases of the target data 131 to which the amount from “501 (ten-thousand yen)” to “1000 (ten-thousand yen)” is set as the “savings” is “1” in the target data 131 to which the age from “30 (years old)” to “39 (years old)” is set as the “age”. Furthermore, “1001-1500:1” indicates that the number of cases of the target data 131 to which the amount from “1001 (ten-thousand yen)” to “1500 (ten-thousand yen)” is set as the “savings” is “1” in the target data 131 to which the age from “30 (years old)” to “39 (years old)” is set as the “age”.

Moreover, in the statistical information 133 illustrated in FIG. 19, “401-500:1” indicates that the cumulative number of times of the target data 131 in which the amount from “401 (ten-thousand yen)” to “500 (ten-thousand yen)” is set as the “savings” is “1” in the target data 131 to which the age from “20 (years old)” to “29 (years old)” is set as the “age”, and the amount from “0 (ten-thousand yen)” to “500 (ten-thousand yen)” is set as the “savings”. Description of other information included in FIG. 19 is omitted.

Then, in the case where “28 (years old)” and “240 (ten-thousand yen)” are specified in the processing in S23, for example, the information management unit 112 counts up the cumulative number of times corresponding to the age from “20 (years old)” to “39 (years old)” to “5”, as illustrated in the underlined part in FIG. 20. Furthermore, in this case, the information management unit 112 counts up the cumulative number of times corresponding to the age from “20 (years old)” to “29 (years old)” to “2”, and counts up the cumulative number of times corresponding to the savings from “0 (ten-thousand yen)” to “500 (ten-thousand yen)” to “2”. Moreover, in this case, the information management unit 112 sets “1” to the cumulative number of times corresponding to the savings from “201 (ten-thousand yen)” to “300 (ten-thousand yen)”.

That is, the information processing device 1 can specify the cumulative number of times of each range corresponding to each granularity for each granularity corresponding to each of the quasi-identifiers by referring to the statistical information 133, as will be described below.

Specifically, in the statistical Information 133 illustrated in FIG. 20, a value of “3” or larger is set to the cumulative number of granularity of every 20 years (“20-39:4”), whereas a value of less than “3” is set to at least one of the cumulative numbers of granularity of every 10 years (“20-29:1” and “30-39:3”) among the granularities corresponding to the “age”. Therefore, for example, in the case of performing k-anonymization with k of 3 for the target data 131, the information processing device 1 determines that the information set to the “age” can be anonymized and output by the granularity of every 20 years, but the information is not able to be anonymized and output by the granularity of every years in the target data 131.

As a result, the information processing device 1 can output useful data to the output terminal 3 while anonymizing the personal information, confidential information, and the like.

[Main Processing of Anonymization Processing]

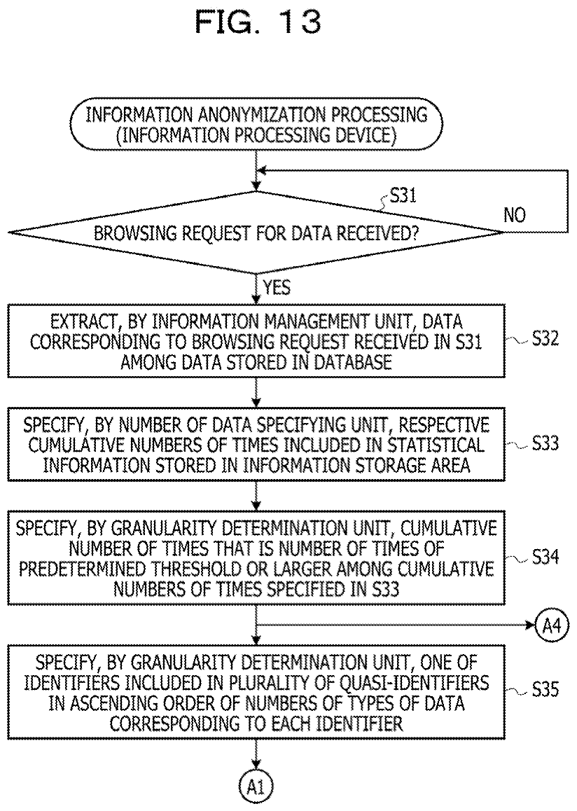

Next, main processing of the anonymization processing will be described. FIGS. 13 to 15 are flowcharts illustrating the main processing of the anonymization processing.

As illustrated in FIG. 13, the information receiving unit 111 waits until receiving the browsing request for the target data 131 from the output terminal 3 (NO in S31), for example.

Then, in the case of receiving the browsing request of the target data 131 from the output terminal 3 (YES of S31), the information management unit 112 extracts the target data 131 corresponding to the received browsing request from the target data 131 stored in the database 1a (S32).

Thereafter, the number of data specifying unit 113 of the information processing device 1 specifies each of the cumulative numbers of times included in the statistical information 133 stored in the information storage area 130 (S33).

Specifically, the number of data specifying unit 113 specifies, for example, each of the cumulative numbers of times included in the statistical information 133 described with reference to FIG. 20.

Next, the granularity determination unit 114 of the information processing device 1 specifies the cumulative number of times that is the number of times equal to or larger than a predetermined threshold among the cumulative numbers of times specified in the processing in S33 (S34).

Specifically, in the case of performing k-anonymization with k of 3 for the target data 131, the granularity determination unit 114 specifies the cumulative number of times to which a value of “3” or larger is set among the cumulative numbers of times specified in the processing in S33.

More specifically, in the statistical information 133 illustrated in FIG. 20, the cumulative number of times included in “20-39:4” and the cumulative number of times corresponding to “30-39:3” are “3” or larger. Therefore, in this case, the granularity determination unit 114 specifies the cumulative number of times corresponding to “20 (years old)” to “39 (years old)” and the cumulative number of times corresponding to “30 (years old)” to “39 (years old)”.

Next, the granularity determination unit 114 specifies one of the identifiers included in the plurality of quasi-identifiers in an ascending order of the number of types of data corresponding to each Identifier (S35).

Specifically, as illustrated in FIG. 20, in the statistical information 133, in a case where the number of types of data corresponding to the “age” is larger than the number of types of data corresponding to the “savings”, the granularity determination unit 114 specifies the “age” first in the processing in S35.

Note that the information indicating the types of data corresponding to each quasi-identifier may be set to the information processing device 1 in advance by the operator, for example.

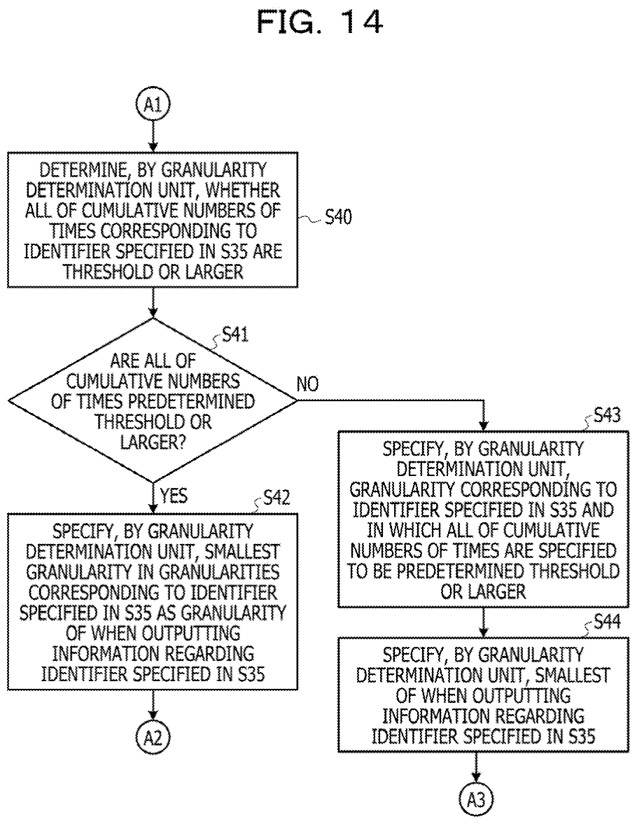

Then, as illustrated in FIG. 14, the granularity determination unit 114 determines whether all of the cumulative numbers of times corresponding to the identifier specified in the processing in S35 have been specified to be equal to or larger than the threshold value (540).

As a result, in the case where not all of the cumulative numbers of times corresponding to the identifier specified in the processing in S35 have been specified to be equal to or larger than the threshold value (NO in S41), the granularity determination unit 114 specifies the granularity corresponding to the identifier specified in the processing in S35 and in which all the cumulative numbers of times are specified to be equal to or larger than the predetermined threshold (S43).

Furthermore, the granularity determination unit 114 specifies the smallest granularity among the granularities specified in the processing in S43 as the granularity of when outputting the information regarding the identifier specified in the processing in S35 (S444).

Specifically, in the statistical information 133 illustrated in FIG. 20, a value of “3” or larger is set to all the cumulative numbers corresponding to the granularity of every 20 years, whereas a value of less than “3” is set to at least one of the cumulative numbers corresponding to the granularity of every 10 years among the granularities corresponding to the “age”. Therefore, in this case, the granularity determination unit 114 specifies the granularity of every 20 years among the granularity corresponding to the “age”.

That is, in this case, the granularity determination unit 114 determines that the information set to the “age” can be anonymized and output by the granularity of every 20 years, but the information is not able to be anonymized and output by the granularity of every 10 years in the target data 131.

Note that, in the case where the granularity is not specified in the processing in S43, the granularity determination unit 114 may not specify the granularity even in the processing in S44.

Thereafter, the information anonymization unit 115 of the information processing device 1 anonymizes the target data 131 extracted by the processing in S32 according to the granularities specified in the processing in S42 and the processing in S44 (S52).

Then, the information output unit 116 of the information processing device 1 outputs the target data 131 (output data 134) anonymized in the processing in S52 to the output terminal 3 (S53). Hereinafter, a specific example of the output data 134 will be described.

[Specific Example of Output Data (1)]

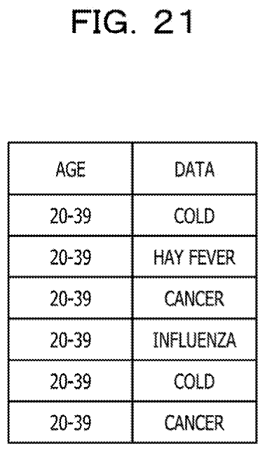

FIGS. 21, 23, and 25 are diagrams for describing specific examples of the output data 134. Specifically, FIG. 21 is a diagram illustrating a specific example of the output data 134 generated by referring to the statistical information 133 illustrated in FIG. 20.

The output data 134 illustrated in FIG. 21 has the “age” and “data” among the items of the output data described in FIG. 4.

Specifically, in the output data 134 illustrated in FIG. 21, “20-39 (years old)” is set as the “age” and “cold” is set as the “data” in the first-row information.

Furthermore, in the output data 134 illustrated in FIG. 21, “20-39 (years old)” is set as the “age” and “hay fever” is set as the “data” in the second-row information. Description of other information included in FIG. 21 is omitted.

That is, in the “age” in the output data 134 illustrated in FIG. 21, information anonymized by the granularity of every 20 years (the granularity determined by the processing of S44) is set.

Returning to FIG. 14, in the case where all the cumulative numbers of times corresponding to the identifier specified in the processing in S35 is equal to or larger than the threshold (YES in S41), the granularity determination unit 114 specifies the smallest granularity among the granularities corresponding to the identifier specified in the processing S35 as the granularity of when outputting the information regarding the identifier specified in the processing in S35 (S42).

Specifically, for example, in the statistical information 133 illustrated in FIG. 22, a value of “3” or larger is set to all the cumulative numbers corresponding to the granularity of every 20 years and all the cumulative numbers corresponding to the granularity of every 10 years among the granularities corresponding to the “age”. Therefore, for example, in the case where the anonymization processing is performed using the statistical information 133 illustrated in FIG. 22, the granularity determination unit 114 specifies the granularity every 10 years as the granularity corresponding to the “age” in the processing in S42.

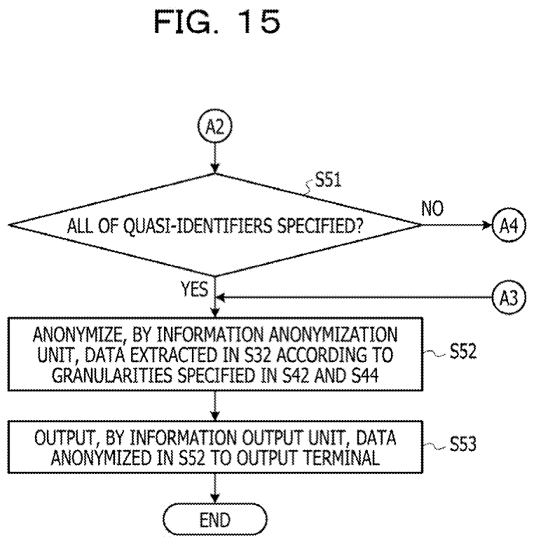

Then, as illustrated in FIG. 15, the granularity determination unit 114 determines whether all the quasi-identifiers have been specified in the processing in S35 (S51).

As a result, in a case where it is determined that not all the quasi-identifiers have not been specified in the processing in S35 (NO in S51), the granularity determination unit 114 repeats the processing in S35 and the subsequent steps.

Specifically, the granularity determination unit 114 performs processing when “savings” is specified in the processing in S35, for example.

More specifically, in the statistical information 133 illustrated in FIG. 22, cumulative numbers of times to which a value less than “3” is set are respectively included in the cumulative number of times corresponding to the granularity of every 500 ten-thousand yen and the cumulative number of times corresponding to the granularity of every 100 ten-thousand yen among the granularities corresponding to the “age” (NO in S41). Therefore, in the case of specifying the “savings” in the processing S35, the granularity determination unit 114 determines that there is no granularity corresponding to the “savings” and in which all the cumulative numbers of times are equal to or larger than the predetermined threshold.

That is, in this case, the granularity determination unit 114 determines that the information set to the “age” in the target data 131 be anonymized and output by the granularity of every 10 years, but the information is not able to be anonymized and output by the granularity corresponding to the information set to the “savings”. Hereinafter, a specific example of the output data 134 generated by referring to the statistical information 133 illustrated in FIG. 22 will be described.

[Specific Example of Output Data (2)]

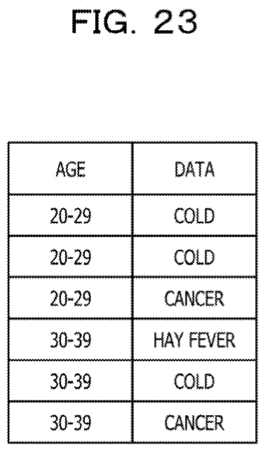

FIG. 23 is a diagram illustrating a specific example of the output data 134 generated by referring to the statistical information 133 illustrated in FIG. 22.

The output data 134 illustrated in FIG. 23 has the “age” and “data” among the items of the output data described in FIG. 4, similarly to the output data 134 described in FIG. 21.

Specifically, in the output data 134 illustrated in FIG. 23, “20-29 (years old)” is set as the “age” and “cold” is set as the “data” in the first-row information.

Furthermore, in the output data 134 illustrated in FIG. 23, “30-39 (years old)” is set as the “age” and “hay fever” is set as the “data” in the fourth-row information. Description of other information included in FIG. 23 is omitted.

That is, in the “age” in the output data 134 illustrated in FIG. 23, information anonymized by the granularity of every 10 years (the granularity determined by the processing of S44) is set.

[Specific Example of Output Data (3)]

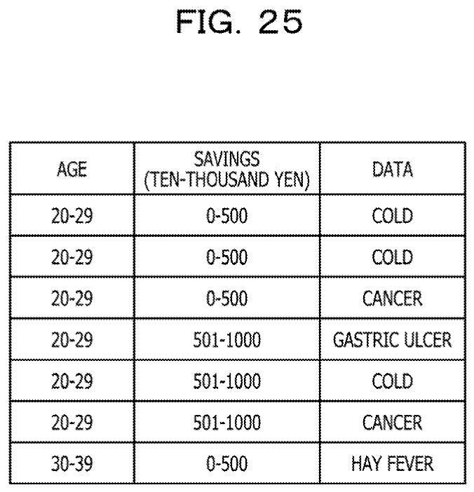

Next, a specific example of the output data 134 generated by referring to the statistical information 133 illustrated in FIG. 24 will be described. FIG. 25 is a diagram illustrating a specific example of the output data 134 generated by referring to the statistical Information 133 illustrated in FIG. 24.

The output data 134 illustrated in FIG. 25 has the same items as the output data described in FIG. 4.

Specifically, in the output data 134 illustrated in FIG. 25, “20-29 (years old)” is set as the “age” and “0-500 (ten-thousand yen)” is set as the “savings”, and “cold” is set as “data” in the first-row information.

Furthermore, in the output data 134 illustrated in FIG. 25, “20-29 (years old)” is set as the “age” and “501-1000 (ten-thousand yen)” is set as the “savings”, and “gastric ulcer” is set as “data” in the fourth-row information.

Moreover, in the output data 134 illustrated in FIG. 25, “30-39 (years old)” is set as the “age” and “0-500 (ten-thousand yen)” is set as the “savings”, and “hay fever” is set as “data” In the seventh-row information. Description of other information included in FIG. 25 is omitted.

That is, in the case where the anonymization processing is performed using the statistical information 133 illustrated in FIG. 24, the granularity of every 10 years is specified as the granularity corresponding to the “age” and the granularity of every 500 ten-thousand yen is specified as the granularity corresponding to the “savings” in the processing in S42 and the processing in S44. Therefore, in this case, information anonymized by the granularity of every 10 years and information anonymized by the granularity of every 500 ten-thousand yen are respectively set to the “age” and “savings” in the output data 134 illustrated in FIG. 25.

As described above, in the case of performing the anonymization processing, the information processing device 1 in the present embodiment specifies the number of data of the target data 131 respectively falling within one or a plurality of ranges respectively corresponding to a plurality of granularities stored in association with the quasi-identifiers among the plurality of target data 131 transmitted from the input terminal 2.

Then, the information processing device 1 determines the granularity of the data of when outputting information regarding the quasi-identifier according to whether the number of data respectively falling within all the ranges corresponding to the same granularity in the plurality of granularities is equal to or larger than a predetermined threshold.

That is, the information processing device 1 according to the present embodiment dynamically changes the granularity of target data 131 to be anonymized according to an accumulation status of the target data 131 transmitted from the input terminal 2 (an appearance state of the target data 131 having overlapping combinations of quasi-identifiers). Then, the information processing device 1 generates the output data 134 not including missing values and transmits the output data to the output terminal 3.

As a result, the information processing device 1 can output the useful output data 134 to the output terminal 3 while anonymizing the personal information, confidential information, and the like.

Note that, in the above example, the case where the data storage processing and the information anonymization processing are performed at different timings has been described. However, the data storage processing and the information anonymization processing may be performed at the same timing.

Specifically, for example, the information processing device 1 may execute the processing in S33 and the subsequent steps for the target data 131 received in the processing in S21 each time the data storage processing is performed.

Thereby, the information processing device 1 can transmit the anonymized target data 131 to the output terminal 3 in real time.

Furthermore, the information processing device 1 may perform the information anonymization processing at predetermined time intervals (for example, every hour). In this case, the information processing device 1 may execute the processing in S33 and the subsequent steps for each of the target data 131 received after the previous information anonymization processing is performed, for example.

Thereby, the information processing device 1 can perform the anonymization processing for the target data 131 without waiting for the browsing request from the output terminal 3.

[Other Specific Examples in Anonymization Processing]

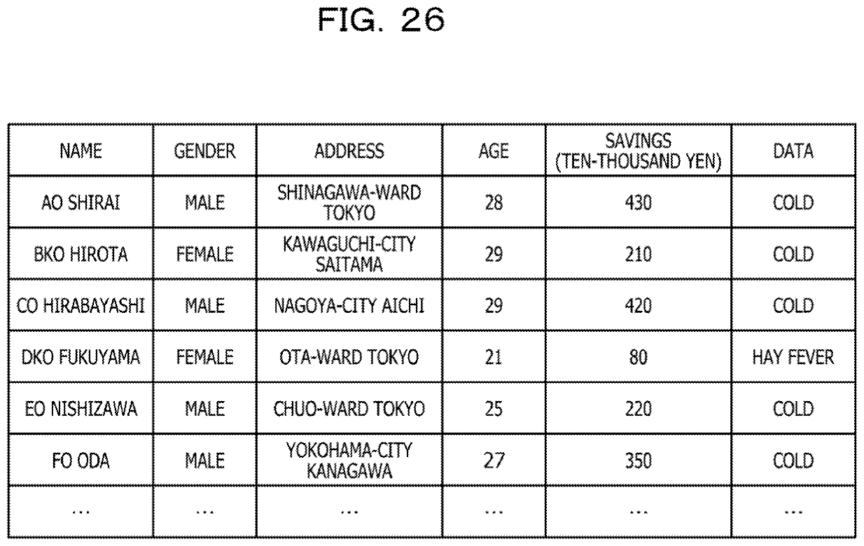

Next, other specific examples of the anonymization processing according to the first embodiment will be described. FIGS. 26 to 28 are diagrams for describing other specific examples of the anonymization processing according to the first embodiment.

[Other Specific Examples of Target Data]

First, a specific example of the target data 131 will be described. FIG. 26 is a diagram for describing another specific example of the target data 131.

The target data 131 illustrated in FIG. 26 has an “address” in which the address of each target person is set, as an item, in addition to the items of the target data 131 described in FIG. 18. Hereinafter, description will be given assuming that the combination of “age”, “savings”, and “address” is the combination of quasi-identifiers.

Specifically, in the target data 131 illustrated in FIG. 26, “Ao Shirai” is set as the “name”, “male” is set as the “gender”, “Shinagawa-ward Tokyo” is set as the “address”, “28 (years old)” is set as the “age”, “430 (ten-thousand yen)” is set as the “savings”, and “cold” is set as “data” in the first-row information.

Furthermore, in the target data 131 illustrated in FIG. 26, “Bko Hirota” is set as the “name”, “female” is set as the “gender”, “Kawaguchi-city Saitama” is set as the “address”, “29 (years old)” is set as the “age”, “210 (ten-thousand yen)” is set as the “savings”, and “cold” is set as “data” in the second-row information. Description of other information included in FIG. 26 is omitted.

[Other Specific Examples of Statistical Information]

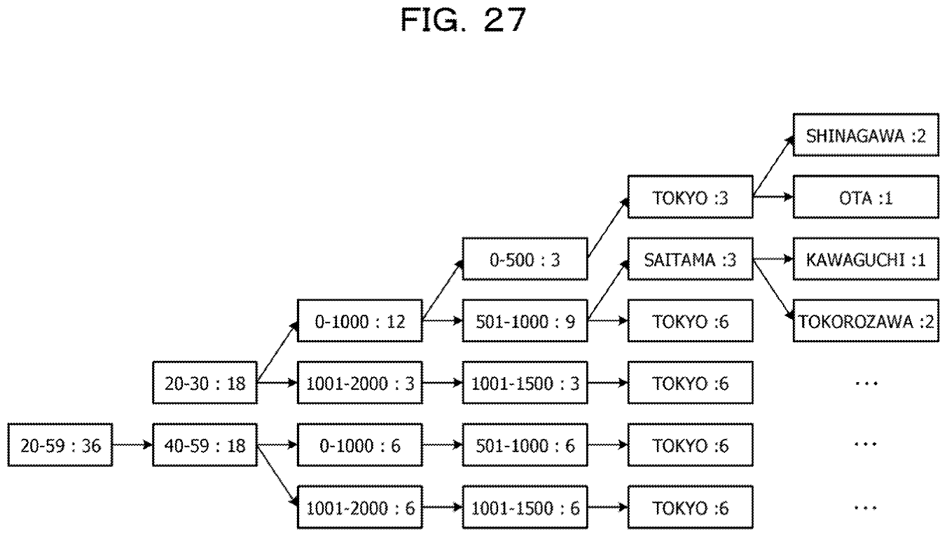

Next, a specific example of the statistical information 133 will be described. FIG. 27 is a diagram for describing another specific example of the statistical Information 133.

The statistical information 133 illustrated in FIG. 27 includes the information of the granularity of every 40 years and the information of the granularity of every 20 years as the information of the granularities corresponding to the “age”. Furthermore, the statistical information 133 illustrated in FIG. 27 includes the Information of the granularity of every 1000 ten-thousand yen and the information of the granularity of every 500 ten-thousand yen as the information of the granularities corresponding to the “savings”.

Moreover, unlike the statistical information 133 described in FIG. 20 and the like, the statistical information 133 illustrated in FIG. 27 includes the information of the granularity for each prefecture and the information of the granularity for each city (ward) as the information of the granularities corresponding to the “address”.

Specifically, in the statistical information 133 illustrated in FIG. 27, a value of “3” or larger is set to all the cumulative numbers corresponding to the granularity of every 40 years and all the cumulative numbers corresponding to the granularity of every 20 years among the granularities corresponding to the “age”. Furthermore, in the statistical information 133 illustrated in FIG. 27, a value of “3” or larger is set to all the cumulative numbers corresponding to the granularity of every 1000 ten-thousand yen and all the cumulative numbers corresponding to the granularity of every 500 ten-thousand yen among the granularities corresponding to the “savings”.

In contrast, in the statistical information 133 shown in FIG. 27, a value less than “3” is set to at least one of the cumulative numbers of granularity for each ward (city) whereas a value of “3” or larger is set to the cumulative number of granularity for each prefecture among the granularities corresponding to the “address”.

Therefore, for example, in the case of performing k-anonymization with k of 3 for the target data 131, the information processing device 1 determines that the information set to the “age” can be anonymized and output by the granularity of every 20 years, and the information set in the “savings” can be anonymized and output by the granularity of every 500 ten-thousand yen in the target data 131. Furthermore, the information processing device 1 determines that the information set to the “address” in the target data 131 can be anonymized and output by the granularity of each prefecture, but the information is not able to be anonymized and output by the granularity of each city (ward).

[Other Specific Examples of Output Data]

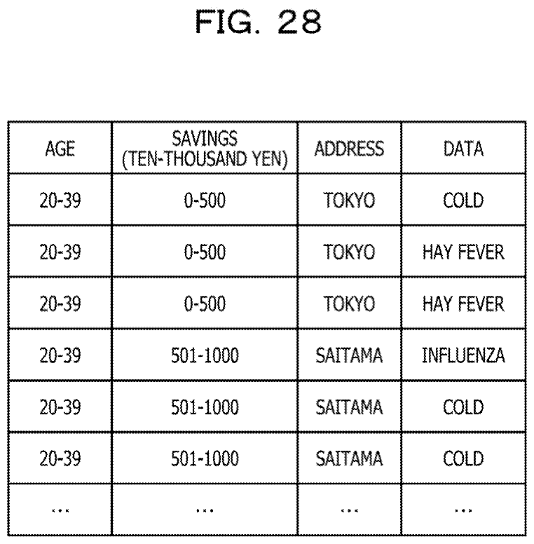

Next, a specific example of the output data 134 will be described. FIG. 28 is a diagram for describing another specific example of the output data 134. Specifically, FIG. 28 is a diagram Illustrating a specific example of the output data 134 generated by referring to the statistical information 133 illustrated in FIG. 27.

The output data 134 illustrated in FIG. 28 has an “address” in which the address of each target person is set, as an item, in addition to the items of the output data 134 described in FIG. 4.

Specifically, in the output data 134 illustrated in FIG. 28, “20-39 (years old)” is set as the “age” and “0-500 (ten-thousand yen)” is set as the “savings”, “Tokyo” is set as the “address”, and “cold” is set as the “data” in the first-row information.

Furthermore, in the output data 134 illustrated in FIG. 28, “20-39 (years old)” is set as the “age” and “0-500 (ten-thousand yen)” is set as the “savings”, “Tokyo” is set as the “address”, and “hay fever” is set as “data” in the second-row information. Description for other information included in FIG. 28 is omitted.

That is, the information processing device 1 specifies the granularity that can be anonymized in order from the granularity corresponding to the quasi-identifier having a small number of types of data even in the case where three or more quasi-identifiers are present in the combination of quasi-identifiers.

Specifically, in the case where not all the cumulative numbers of times corresponding to the quasi-identifier specified in the processing in S35 performed in the Nth time (N is an integer of 3 or larger) are equal to or larger than a predetermined threshold (NO in S41), the information processing device 1 specifies, for each of quasi-identifiers specified in the processing in S35 performed up to the (N−1)th time, the smallest granularity in the granularities corresponding to the each quasi-identifier as the granularity of when outputting the information of the each quasi-identifier (S42).

Furthermore, in this case, the information processing device 1 specifies the smallest granularity in the granularities in which all the cumulative numbers corresponding to the quasi-identifier specified in the processing in S35 performed in the Nth time are equal to or larger than the predetermined threshold, as the granularity of when outputting the information regarding the quasi-identifier specified in the processing in S35 performed in the Nth time (S43 and S44).

As a result, the information processing device 1 outputs the useful output data 134 to the output terminal 3 while anonymizing the personal information, confidential information, and the like, even in the case where three or more quasi-identifiers are present in the combination of quasi-identifiers.

All examples and conditional language provided herein are intended for the pedagogical purposes of aiding the reader in understanding the invention and the concepts contributed by the Inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium for storing an information processing program which causes a processor to perform processing, the processing comprising:
specifying a number of data of data respectively falling within one or a plurality of ranges respectively corresponding to a plurality of granularities stored in a storage device in association with a specific identifier among a plurality of data; and
determining a granularity of data of when outputting Information regarding the specific identifier according to whether the number of data respectively falling within all the ranges corresponding to a same granularity in the plurality of granularities is equal to or larger than a predetermined threshold.

2. The non-transitory computer-readable storage medium according to claim 1, wherein the determining is configured to:
specify one or more granularities in which the number of data respectively falling within all of the ranges corresponding to each granularity is determined to be equal to or larger than the predetermined threshold among the plurality of granularities; and
determine a smallest granularity in the specified one or more granularities as the granularity of data of when outputting information regarding the specific identifier.

3. The non-transitory computer-readable storage medium according to claim 1, wherein
the specific identifier includes a plurality of Identifiers,
the specifying is configured to specify, for each of the plurality of identifiers, the number of data corresponding to the each identifier, and
the determining is configured to determine, for each of the plurality of identifiers, the granularity of data of when outputting information corresponding to the each identifier.

4. The non-transitory computer-readable storage medium according to claim 3, wherein
the determining is configured to:
determine, for each of the plurality of identifiers and for each of the plurality of granularities, whether the number of data respectively falling within all the ranges corresponding to the each granularity is equal to or larger than the predetermined threshold;
specify one or more granularities in which the number of data respectively falling within all the ranges corresponding to the each granularity is determined to be equal to or larger than the predetermined threshold, among the plurality of granularities corresponding to a first identifier included in the plurality of identifiers; and
in a case where the specified one or more granularities are not all the plurality of granularity corresponding to the first identifier, determine a smallest granularity in the specified one or more granularities as the granularity of data of when outputting information regarding the specific identifier.

5. The non-transitory computer-readable storage medium according to claim 4, wherein
the determining is configured to:
in a case where the one or more granularities are all the plurality of granularities corresponding to the first identifier, specify one or more granularities in which the number of data respectively falling within all the ranges corresponding to the each granularity is determined to be equal to or larger than the predetermined threshold, among the plurality of granularities corresponding to a second identifier included in the plurality of identifiers; and
determine a smallest granularity in the plurality of granularities corresponding to the first identifier as the granularity of data of when outputting information regarding the first Identifier, and determining a smallest granularity in the one or more granularities corresponding to the second identifier as the granularity of data of when outputting information regarding the second identifier.

6. The non-transitory computer-readable storage medium according to claim 5, wherein
the first identifier is an identifier having a smaller number of types of data in the plurality of data than the second identifier.

7. The non-transitory computer-readable storage medium according to claim 5, wherein,
the determining is configured to: in a case where the one or more granularities corresponding to the second identifier are not all the plurality of granularities corresponding to the second identifier,
determine a smallest granularity in the plurality of granularities corresponding to the first identifier as the granularity of data of when outputting information regarding the first identifier; and
determine a smallest granularity in the one or more granularites corresponding to the second identifier as the granularity of data of when outputting information regarding the second identifier.

8. The non-transitory computer-readable storage medium according to claim 7, wherein
the determining is configured to:
in a case where the one or more granularities corresponding to the second identifier are all the plurality of granularities corresponding to the second identifier, repeatedly perform, for each of the other identifiers than the first and second identifiers included in the plurality of identifiers, processing of specifying the one or more granularities corresponding to the each identifier until the one or more granularities corresponding to the each identifier become not all the plurality of granularities corresponding to the each identifier; and
in a case where the one or more granularities corresponding to an Nth (N is an integer of 3 or larger) identifier included in the plurality of identifiers are not all the plurality of granularities corresponding to the Nth identifier, determine a smallest granularity in the plurality of granularities respectively corresponding to the first identifier to an (N−1)th identifier included in the plurality of identifiers as the granularity of data of when outputting information regarding the first identifier to the (N−1)th identifier, and determine a smallest granularity in the one or more granularities corresponding to the Nth identifier as the granularity of data of when outputting information regarding the Nth identifier.

9. An information processing device comprising:
a memory; and
a processor coupled to the memory, the processor being configured to perform processing, the processing including:
specifying a number of data of data respectively falling within one or a plurality of ranges respectively corresponding to a plurality of granularities stored in a memory in association with a specific identifier among a plurality of data; and
determining a granularity of data of when outputting information regarding the specific identifier according to whether the number of data respectively falling within all the ranges corresponding to a same granularity in the plurality of granularities is equal to or larger than a predetermined threshold.

10. The information processing device according to claim 9, wherein the determining is configured to:
specify one or more granularities in which the number of data respectively falling within all of the ranges corresponding to each granularity is determined to be equal to or larger than the predetermined threshold among the plurality of granularities; and
determine a smallest granularity in the specified one or more granularities as the granularity of data of when outputting information regarding the specific identifier.

11. The information processing device according to claim 9, wherein
the specific identifier includes a plurality of identifiers,
the specifying is configured to specify, for each of the plurality of identifiers, the number of data corresponding to the each identifier, and
the determining is configured to determine, for each of the plurality of identifiers, the granularity of data of when outputting information corresponding to the each identifier.

12. The information processing device according to claim 11, wherein
the determining is configured to:
determine, for each of the plurality of identifiers and for each of the plurality of granularities, whether the number of data respectively falling within all the ranges corresponding to the each granularity is equal to or larger than the predetermined threshold;
specify one or more granularities in which the number of data respectively falling within all the ranges corresponding to the each granularity is determined to be equal to or larger than the predetermined threshold, among the plurality of granularities corresponding to a first identifier included in the plurality of identifiers; and
in a case where the specified one or more granularities are not all the plurality of granularity corresponding to the first identifier, determine a smallest granularity in the specified one or more granularities as the granularity of data of when outputting information regarding the specific identifier.

13. An information processing method implemented by a computer, the computer-based method comprising:
specifying a number of data of data respectively falling within one or a plurality of ranges respectively corresponding to a plurality of granularities stored in a memory in association with a specific identifier among a plurality of data; and
determining a granularity of data of when outputting Information regarding the specific identifier according to whether the number of data respectively falling within all the ranges corresponding to a same granularity in the plurality of granularities is equal to or larger than a predetermined threshold.

14. The information processing method according to claim 13, wherein the determining is configured to:
specify one or more granularities in which the number of data respectively falling within all of the ranges corresponding to each granularity is determined to be equal to or larger than the predetermined threshold among the plurality of granularities; and
determine a smallest granularity in the specified one or more granularities as the granularity of data of when outputting information regarding the specific identifier.

15. The information processing method according to claim 13, wherein
the specific identifier includes a plurality of identifiers,
the specifying is configured to specify, for each of the plurality of identifiers, the number of data corresponding to the each identifier, and
the determining is configured to determine, for each of the plurality of identifiers, the granularity of data of when outputting information corresponding to the each identifier.

16. The information processing method according to claim 13, wherein
the determining is configured to:
determine, for each of the plurality of identifiers and for each of the plurality of granularities, whether the number of data respectively falling within all the ranges corresponding to the each granularity is equal to or larger than the predetermined threshold;
specify one or more granularities in which the number of data respectively falling within all the ranges corresponding to the each granularity is determined to be equal to or larger than the predetermined threshold, among the plurality of granularities corresponding to a first identifier included in the plurality of identifiers; and
in a case where the specified one or more granularities are not all the plurality of granularity corresponding to the first identifier, determine a smallest granularity in the specified one or more granularities as the granularity of data of when outputting information regarding the specific identifier.
